(19) United States
(12) Patent Application Publication
(10) Pub. No.: US 2024/0270078 A1
(43) Pub. Date: Aug. 15, 2024

(54) RECOVERING ENERGY FROM A ROTATING VEHICLE WHEEL AND DEVICE, METHOD AND DISC ROTOR THEREFOR

(71) Applicant: REBUS CORPORATION PTY LTD, Victoria (AU)

(72) Inventor: Peter BLOOMFIELD, Victoria (AU)

(73) Assignee: REBUS CORPORATION PTY LTD, Victoria (AU)

(21) Appl. No.: 18/692,267

(22) PCT Filed: Sep. 15, 2022
(86) PCT No.: PCT/AU2022/051112

§ 371 Date: Mar. 14, 2024

(30) Foreign Application Priority Data
Sep. 15, 2021 (AU) 2021902971

(51) Int. Cl. B60L 7/10; H02K 3/04; H02P 3/18

(52) U.S. Cl. CPC B60L 7/10; H02K 3/04; H02P 3/18

(57) ABSTRACT

A device for recovering energy from a rotating vehicle wheel, comprising: a hub assembly coupled to the wheel and having spaced apart and interlocked outer and inner discs between which a static magnetic field is created; and a stator coil disposed coaxial to the hub assembly and extending within the air gap between the outer and inner discs, the stator coil being fixed relative to the hub, wherein rotation of the hub generates an electrical current in the coil.

### FIELD OF THE INVENTION

The present disclosure relates to recovering energy from a rotating vehicle wheel and a device, method and disc rotor therefore.

### BACKGROUND

Range limitations are a psychological barrier to use of presently available electric vehicles. Although one option to increase range is to increase battery storage, this increases the weight of the vehicle and reduces its efficiency. As such, it is more desirable and generally more cost effective to try and increase the efficiency of an electric vehicle so that it can travel further on the same amount of energy.

One way to improve the efficiency of an electric vehicle is to include energy recovery and/or conversion systems that convert mechanical or potential energy into electrical energy that is fed back to a battery. Regenerative braking systems are an example of such a system, though such systems are typically implemented at the electric motor and although they contribute to braking efforts, they are not highly effective at capturing energy that would otherwise be lost.

It is desirable to provide a more effective recovery system that recovers a higher level of electrical energy.

Another factor reducing electric vehicle range is dissipation of energy within a standard electrochemical battery with the rate of dissipation estimated to be around 5%, though will vary according to a number of factors including the battery size, load applied, and friction applied due to heat loss, sound or any number of external environmental impacts.

It is desirable to provide a relatively low-level recharging power supply during use of the vehicle. This recharging power supply would ideally be provided through a conversion of potential energy to electrical energy.

There is a need to address the above, and/or at least provide a useful alternative.

### SUMMARY

According to a first aspect of the present invention, there is provided a device for recovering energy from a rotating vehicle wheel, comprising:
a hub assembly coupled to the wheel and having spaced apart and interlocked outer and inner discs between which a static magnetic field is created; and
a stator coil disposed coaxial to the hub assembly and extending within the air gap between the outer and inner discs, the stator coil being fixed relative to the hub, wherein rotation of the hub generates an electrical current in the coil.

According to a preferred embodiment of the present invention, the outer and inner discs have, on opposing surfaces thereof, a plurality of permanent magnets disposed around a periphery of the disc with the magnetic axis of each magnet being generally normal to the surface of the disc; the orientation of the magnetic axis of adjacent magnets on each disc alternates; and the orientation of magnets opposing each other on the spaced apart discs is oppositely arranged.

Preferably, the permanent magnets of each disc are mounted on a respective annular magnetic yoke. Preferably, the permanent magnets of each disc are restrained with outer and inner rings disposed in generally the same plane as the magnets.

Preferably, the stator coil is formed of at least one annular disc having a plurality of generally spiral shaped coils disposed around a periphery thereof, each winding being connected in series. In one embodiment the device comprises 12 annular discs, arranged into two groups of 6 discs each, the discs of each group being electrically connected in series with the two groups being connected together in parallel.

Preferably, there are 12 pairs of coils disposed around the periphery of each disc, the individual coils being connected into three groups so as to generate three phase power. Preferably, the coils are formed with thicker and thinner portions and arranged so that the magnetic flux generated by the magnets in incident only on the thinner portions. Preferably, each annular disc is formed of four printed circuit board (PCB) layers, a top layer having the coils formed on and the remaining layers being used for interconnection of the coils for different phases.

Preferably, the stator coil forms part of an electrical circuit for distribution of energy generated therein, the device further including a switch for selectively opening and closing the circuit, whereby closing the circuit applies a magnetic resistance torque to the hub assembly to assist in braking the vehicle.

According to another aspect of the invention, there is provided a hub assembly for use in recovering energy from a rotating vehicle wheel, the hub assembly formed of spaced apart outer and inner discs between which a static magnetic field is created, the hub assembly configured to receive a stator coil disposed coaxial thereto and extending within the air gap between the outer and inner discs, the stator coil being configured to be, in use, fixed relative to the vehicle, whereby rotation of the hub assembly generates an electrical current in the coil.

Preferably, the outer and inner discs have, on opposing surfaces thereof, a plurality of permanent magnets disposed around a periphery of each disc with the magnetic axis of each magnet being generally normal to the surface of the disc to which it is mounted; the orientation of the magnetic axis of adjacent magnets on each disc alternates; and the orientation of magnets opposing each other on the spaced apart discs is oppositely arranged.

According to another aspect of the invention, there is provided a method of recovering energy from a rotating vehicle wheel, including the steps of:
providing a device of the above-described type; and
using the energy generated to recharge an electrical storage device of the vehicle.

Preferably, the device is operable to open and close an electrical circuit that forms part of the device to vary the magnetic resistance torque applied to the hub assembly to assist with braking the vehicle.

Preferably, the method is performed during forward or rearward motion of the vehicle.

According to another aspect of the invention, there is provided a vehicle including at least one device of the above-described type. Preferably, the or each device is fitted to the or each rear wheel of the vehicle.

### BRIEF DESCRIPTION OF THE DRAWINGS

An embodiment of the invention will now be described, by way of example only, with reference to the accompanying drawings in which:

FIG. 1 is a perspective view of a device for recovering energy from a rotating vehicle wheel according to one embodiment of the invention;

FIG. 2 is a sectioned view of the device of FIG. 1;

FIG. 3 is an exploded view of the device of FIG. 1;

FIG. 4 is an upper side sectional view of the device of FIG. 1;

FIG. 5 is a side view of a device for recovering energy from a rotating vehicle wheel according to another embodiment of the invention;

FIG. 6 is a partial exploded view of the device;

FIGS. 7a and 7b are respective side and front views of an outer disc of a hub assembly with mounted permanent magnets;

FIGS. 8a and 8b are respective side and front views of an inner disc of a hub assembly with mounted permanent magnets;

FIG. 9 is a sectioned top view of the hub assembly;

FIGS. 10a, 10b and 10c are respective front, back and close views of a first annular disc of a stator coil;

FIGS. 11a and 11b are respective side views of upper and lower rotor coils, together forming a stator coil of a second embodiment;

FIG. 12 is a side perspective view of the stator coil in series of the second embodiment;

FIG. 13 is a close side view of electrical coils on the stator coil of the second embodiment; and

FIG. 14 is a close sectional view of the stator coil, rotor, magnetic field and air gap.

### DETAILED DESCRIPTION

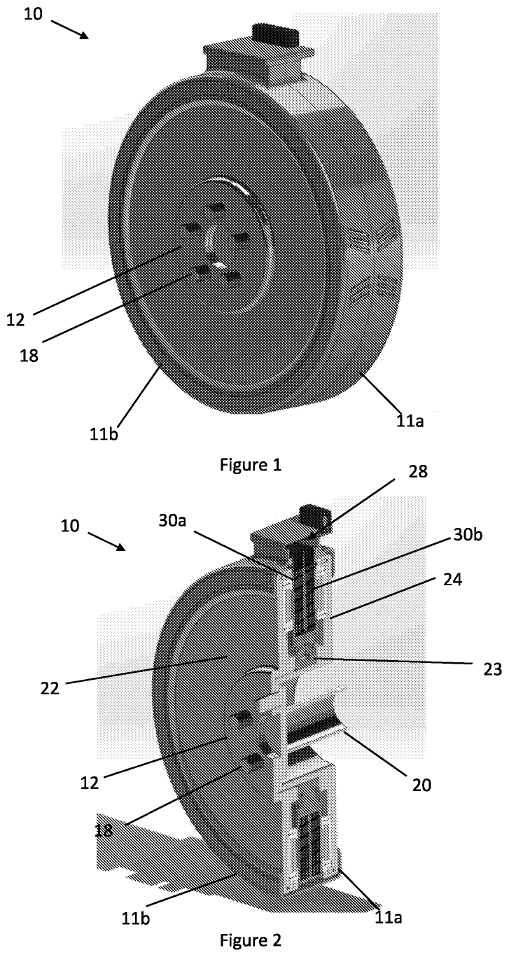

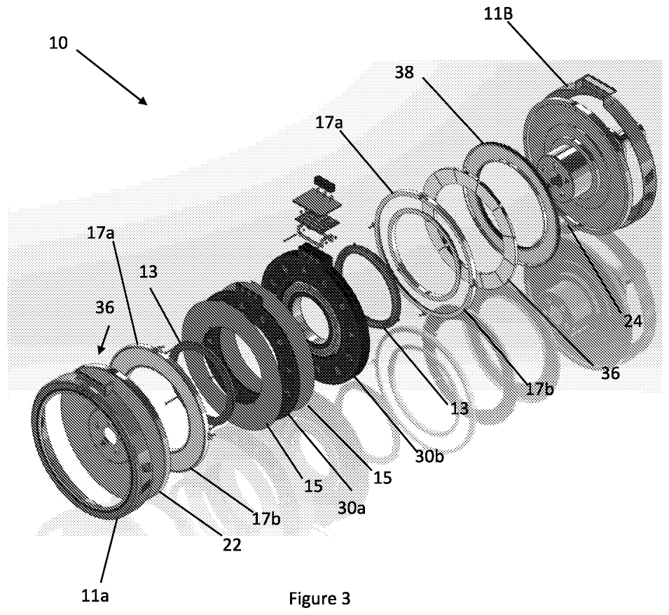

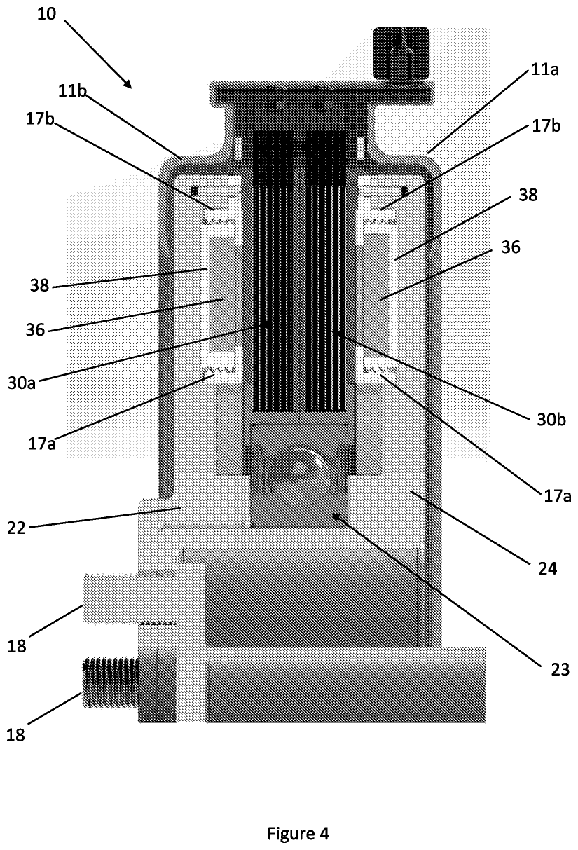

A device 10 according to a preferred embodiment of the invention is shown in FIG. 1. The device 10 is configured for recovering energy from a rotating vehicle wheel. In a preferred form the vehicle is a four wheel automobile, though it will be appreciated that the invention will also apply to vehicles with other numbers of wheels, such as motorbikes, six wheel vehicles, trucks and trailers with varying axle configurations, or trains.

The described and illustrated embodiments all relate to an electric vehicle and the energy recovered is converted to electrical power for use in charging an electrical storage device of the electric vehicle, which may be batteries, a super capacitor, or other electrical storage device.

Device 10 is mounted in close proximity to the wheel of the vehicle as the inventor considers that the point of maximum potential for energy transfer from mechanical to electrical energy within a conventional transportation motor vehicle (or any wheel) would most likely include an interaction with the wheel. Incorporation into a disc brake system may be possible in alternative embodiments.

The device 10 includes a hub assembly 12 mounted on wheels studs 18. Hub 12 is mounted to axle 20 of the vehicle.

The hub assembly 12 includes outer disc 22 and inner disc 24 which are separated by an air gap 28. As will be described further below, between the discs 22, 24 a static magnetic field is created which extends through air gap 28.

The outer and inner discs 22, 24 may be formed of cast iron as is conventionally done, though to reduce magnetic resistance torque in the system, they will preferably be formed of reinforced carbon-carbon or ceramic matrix composites.

Within air gap 28 a stator coil 30 (which is shown as formed of individual coils 30a, 30b) is disposed coaxial to the hub assembly 12. By extending within the air gap 28 between the outer and inner discs 22, 24, the stator coil 30 intersects at right angles the magnetic field for the purpose of inducing an electrical current therein. In use, the stator coil 30 is fixed relative to the axle 20 so that rotation of the hub assembly 12 causes relative movement of a coil (the stator coil 30) through a magnetic field to generate electricity.

The components of device 10 are disposed with a cover, formed of inner part 11a and outer part 11b. As can be seen, and which will be described in further detail below, stator coil 30 is formed as two sub-assemblies 30a, 30b, each sitting on a support 13. Insulating discs 15 are disposed between the coils 30a, 30b. Bearing 23 is provided to support the stator coil 30 and allow rotation between the hub assembly 12 and the stator coil 30.

Magnets 36 are provided to create the magnetic field and are mounted on a magnetic yoke 38 and held in place with inner support 17a and outer support 17b.

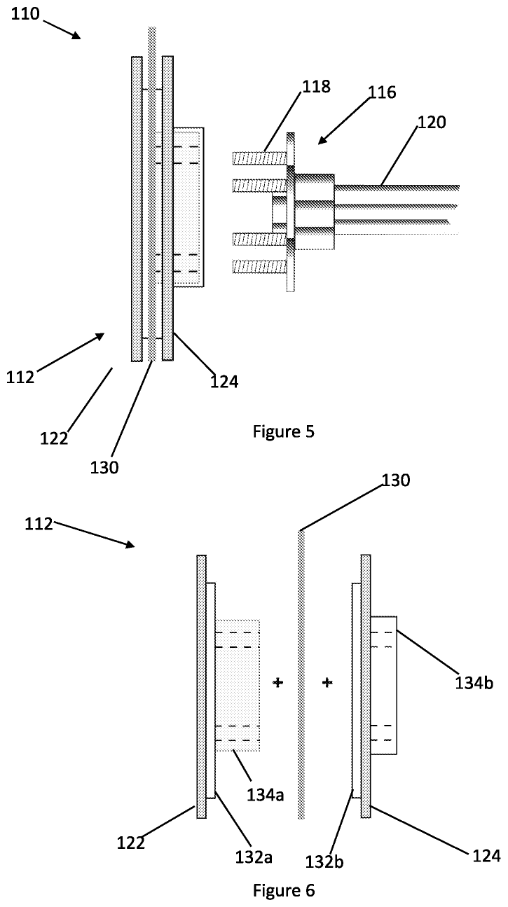

FIGS. 5 and 6 illustrate a device 110 of a second embodiment of the invention. Device 110 includes a slightly differently configured hub assembly 112. In this embodiment, outer disc 122 and inner disc 124 are spaced apart though secured together in interlocking arrangement via mounting flanges 132a, 132b which are secured together in face-to-face relationship and are mounted on hub parts 134a, 134b.

Although only described in relation to the first embodiment 10, the following description of the configuration and operation of the magnets is intended to apply to both embodiments of the device 10, 110.

To create the magnetic field within air gap 28, the outer and inner discs 22, 24 have, on opposing surfaces thereof, a plurality of permanent magnets 36 disposed thereon or embedded within. The magnets 36 are disposed around a periphery of each disc 22, 24 and mounted on an annular magnetic yoke 38. The magnets 36 are arranged so that the magnetic axis of each magnet 36 is generally normal to the surface of the disc.

Permanent magnets 36 are preferably formed from a material with a higher residual induction such as NdFeB N52 (Neodymium iron boron), which has a residual induction of 1.43 T and relative permeability of 1.05.

Yokes 38 are provided to reduce the magnetic resistance torque and magnetic flux leakage as well as to improve the magnetic flux density in the air gap 28. Yokes 38 are preferably made of soft magnetic materials. To achieve a high saturation flux density to decrease yoke volume and a high magnetic permeability to decrease leakage flux, permalloy 1J85, permalloy 1J50, electromagnetic pure iron and ferrocobalt 1J22 may be examples of suitable materials. Having regard to the potential impact of heat generation during usage of the hub assembly 12, heat treated permalloy 1J50 may be most suitable.

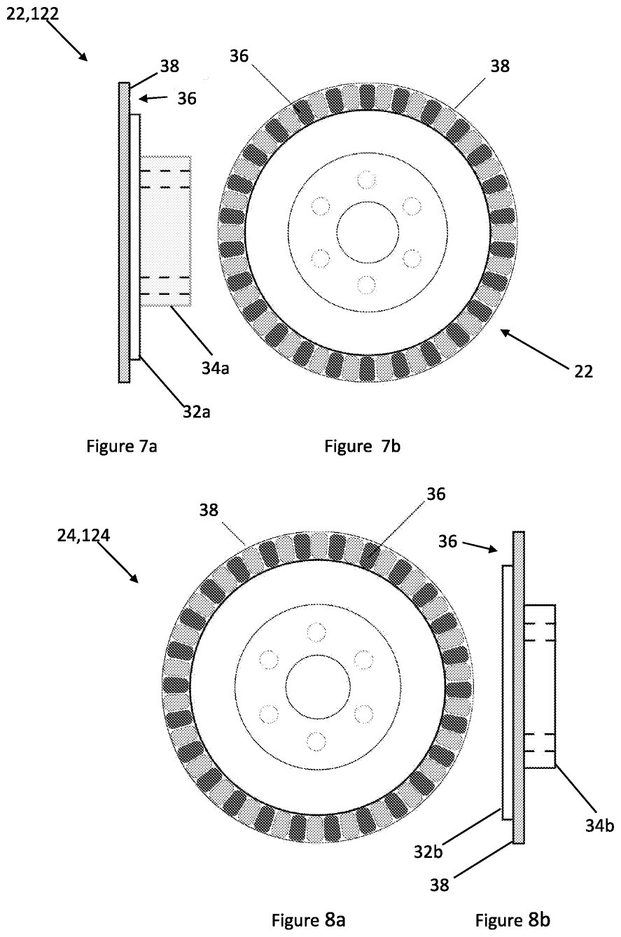

The orientation of the magnets 36 is such that adjacent magnets are alternatingly arranged, i.e., the magnetic axis of adjacent magnets on each disc alternates. With reference to FIGS. 7B, 8A and FIG. 9, it can be seen that a magnet with a visible north pole is placed next to a magnet with its opposite pole, i.e., the south pole, visible.

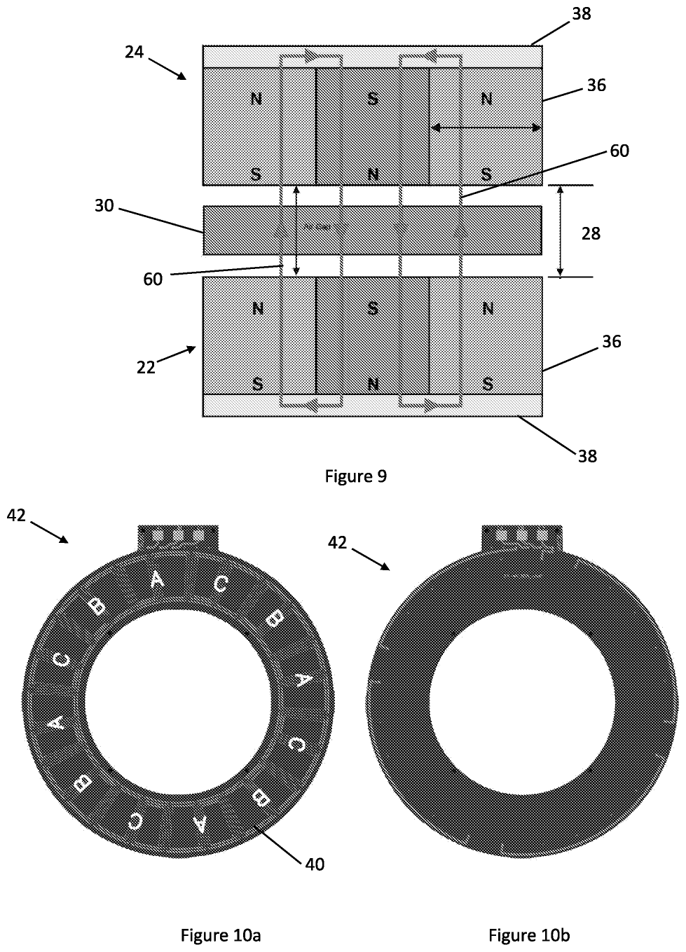

The hub assembly 12 is also arranged so that when the outer disc 22 and inner disc 24 are secured together, the orientation of magnets opposing each other on the spaced apart discs 22, 24 is oppositely arranged. This can be seen in FIG. 9 whereby on the outer disc 22, a permanent magnet 36 with an outward north pole is opposite a permanent magnet 36 with an outward south pole. This results in the magnetic flux line 60 shown in FIG. 9, whereby the magnetic field passes through the air gap 28 such that stator coil 30 passes through the magnetic field and rotation of the stator coil 30 results in an electrical current being generated in the stator coil 30. Owing to such an arrangement, when in motion the device 10 will harvest mechanical to electrical energy from the rotation.

The inventor believes that by configuring the outer and inner discs 22, 24 with permanent magnets as disclosed herein, it will be possible to establish a static magnetic field between discs 22, 24, as illustrated in FIG. 9, i.e., one which passes directly across the air gap 28. This static magnetic field is expected to reduce magnetic resistive torque so that electricity can be generated during normal forward or rearward motion of the vehicle. Owing to the described arrangement, the static magnetic field is also expected to reduce hysteresis loss and eddy-current loss, thereby greatly improving generating performance. In an alternative form of operation, the device 10 may be used as a regenerative braking system.

Each coil 30, 30b is formed of multiple annular discs 42. Preferably, stator coil 30 is formed of 12 annular discs arranged into two groups of 6 discs each. The discs 42 of each group are electrically connected in series with the two groups being connected together in parallel.

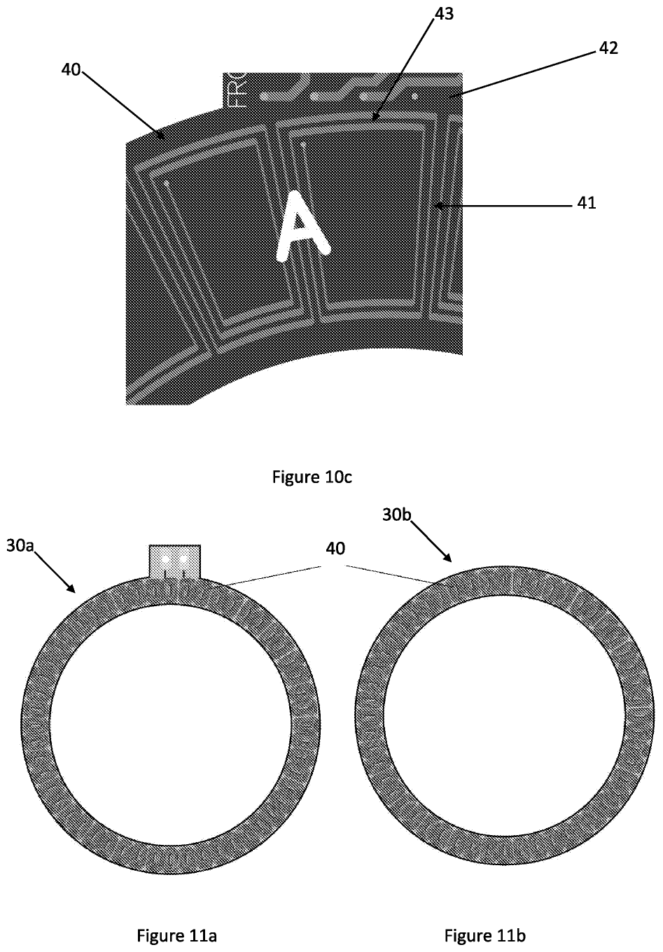

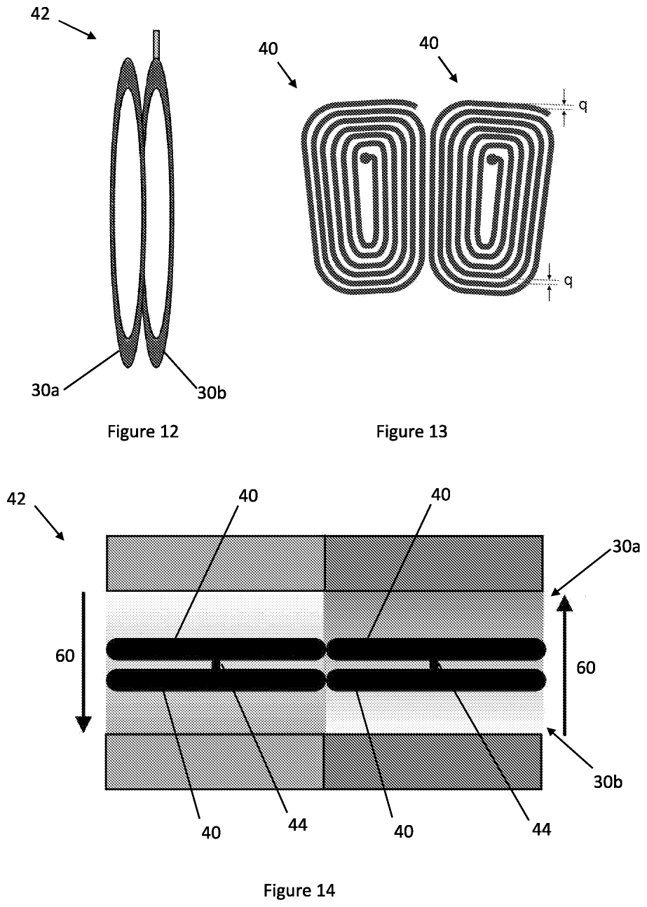

FIGS. 10a and 10b illustrate front and rear views of a disc 42. In a preferred form, each annular disc 42 is formed of four PCB layers, a top layer having the coils 40 formed on (see FIG. 10a) and the remaining layers being used for interconnection of the coils 40 for different phases.

On each disc 42 there are 12 pairs of coils disposed around the periphery of the disc, the individual coils being connected into three groups A, B and C (see FIG. 10a), so as to generate three phase power.

As can be seen in FIG. 10c, in one embodiment the coils 40 are formed with thicker and thinner portions and arranged so that the magnetic flux generated by the magnets is incident only on the thinner portions. In this regard, the thinned portions 41 of the coil extend generally radially on the disc 42 whereas the thicker portions 43 extend in a direction generally circumferential though inset for a periphery of the disc 42.

In the embodiment of FIGS. 11a, 11b, the coils 40 (shown in detail in FIG. 13) take a more regular, somewhat circular, shape.

Each annular disc 42 is fabricated by printed circuit board (PCB) technology and made of non-magnetic materials with copper for the wires. The base is preferably glass-bonded mica with a relatively high permittivity (dielectric constant) of 6.3 to 9.3. The importance of this material is to absorb the resultant magnetic field created when a current is produced within the coil structure whilst moving through a magnetic field. This material will provide the capacitance required to reduce the magnetic torque otherwise created within a standard coil winding as determined in accordance with Lenz's Law. Compared with the coils fabricated by traditional filament winding method, the PCB based multilayer coil integrates coils and substrates within an integrated thin structure, leading to a smaller air-gap 28 thickness and higher air-gap 28 magnetic flux density, hence better output performance.

The number, configuration and overall design of the coil structure will be important to maximise the effect of magnetic flux and output voltage in relation to rotational speed, and may vary from that shown.

The device 10 may include an electronic circuit 46 (not shown), which the stator coil 30 may be considered to be a part of, is configured for the distribution of energy generated within the device 10.

The electronic circuit may include a full bridge rectifier followed by a smoothing capacitor. The voltage may then be regulated by a linear voltage regulator which is required as the power supplied will increase and decrease based on the speed of the wheel turning. The signal may then be passed to a DC-to-DC converter to drop the voltage to 11.1V, 3.3 A for charging a battery. It will be appreciated that the described voltage and current is for a particular vehicle and may vary depending on the specific application. The output power is then either used to charge the battery or electrical storage devices (ie super capacitor) with current dividers in place due to individual cell charging, or directly supplied to the input line to reduce discharge of the battery. A sensor flow regulator may be provided at the gateway to battery or electrical storage devices cell charging. This sensor will determine when and to which individual cell will require the greatest flow of output power and be regulated to determine at exactly which point in time. This requirement of sensor flow regulation will enable greater efficiency of energy flow and result in minimal quantity of battery or electrical storage storage devices.

Device 10 may further include a switch for opening and closing the electronic circuit. If opened, magnetic resistance torque may be completely eliminated and reinstated as required. This allows the device to act in dual modes, a first mode in which low level electrical power is generated while the vehicle is in motion, and a second mode in which high level electrical power is generated during braking. To achieve this, magnetic resistance torque may be increased such that the device harnesses any magnetic torque to assist with the braking of the vehicle's braking system to slow the vehicle while generating electrical power that can be used to charge the battery or electrical storage device. The switch may take different forms, such as mechanical and electrical.

Many modifications of the above embodiments will be apparent to those skilled in the art without departing from the scope of the present invention. For example, although the device is shown as being located in close proximity to the wheel, it may be mounted at other locations on the vehicle.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A device for recovering energy from a rotating vehicle wheel, comprising:
a hub assembly coupled to the wheel and having spaced apart and interlocked outer and inner discs between which a static magnetic field is created; and
a stator coil disposed coaxial to the hub assembly and extending within the air gap between the outer and inner discs, the stator coil being fixed relative to the hub, wherein rotation of the hub generates an electrical current in the coil.

2. A device according to claim 1, wherein:
the outer and inner discs have, on opposing surfaces thereof, a plurality of permanent magnets disposed around a periphery of the disc with the magnetic axis of each magnet being generally normal to the surface of the disc;
the orientation of the magnetic axis of adjacent magnets on each disc alternates; and
the orientation of magnets opposing each other on the spaced apart discs is oppositely arranged.

3. A device according to claim 1, wherein the permanent magnets of each disc are mounted on a respective annular magnetic yoke.

4. A device according to claim 3, wherein the permanent magnets of each disc are restrained with outer and inner rings disposed in generally the same plane as the magnets.

5. A device according to claim 1, wherein the stator coil is formed of at least one annular disc having a plurality of generally spiral shaped windings disposed around a periphery thereof, each winding being connected in series.

6. A device according to claim 5, comprising 12 annular discs, arranged into two groups of 6 discs each, the discs of each group being electrically connected in series with the two groups being connected together in parallel.

7. A device according to claim 6, wherein there are 12 pairs of coils disposed around the periphery of the disc, the individual coils being connected into three groups so as to generate three phase power.

8. A device according to claim 5, wherein the coils are formed with thicker and thinner portions and arranged so that the magnetic flux generated by the magnets in incident only on the thinner portions.

9. A device according to claim 5, wherein each annular disc is formed of four PCB layers, a top layer having the coils formed on and the remaining layers being used for interconnection of the coils for different phases.

10. A device according to claim 1, wherein the stator coil forms part of an electrical circuit for distribution of energy generated therein, the device further including a switch for selectively opening and closing the circuit, whereby closing the circuit applied a magnetic resistance torque to the hub assembly to brake the vehicle.

11. A hub assembly for use in recovering energy from a rotating vehicle wheel, the hub assembly formed of spaced apart outer and inner discs between which a static magnetic field is created, the hub assembly configured to receive a stator coil disposed coaxial thereto and extending within the air gap between the outer and inner discs, the stator coil being configured to be, in use, fixed relative to the vehicle, whereby rotation of the hub assembly generates an electrical current in the coil.

12. A hub assembly according to claim 11, wherein
the outer and inner discs have, on opposing surfaces thereof, a plurality of permanent magnets disposed around a periphery of each disc with the magnetic axis of each magnet being generally normal to the surface of the disc to which it is mounted;
the orientation of the magnetic axis of adjacent magnets on each disc alternates; and
the orientation of magnets opposing each other on the spaced apart discs is oppositely arranged.

13. A method of recovering energy from a rotating vehicle wheel, including the steps of:
providing a device according to claim 1; and
using the energy recovered to recharge an electrical storage device of the vehicle.

14. A method according to claim 13, wherein the device is operable to open and close an electrical circuit that forms part of the device to vary the magnetic resistance torque applied to the hub assembly to assist with braking the vehicle.

15. A method according to claim 13, performed during forward or rearward motion of the vehicle.

16. A vehicle, including at least one device according to claim 1.

17. A vehicle according to claim 16, wherein each device is fitted to the rear wheel of the vehicle.
